(19) United States
(12) Patent Application Publication
(10) Pub. No.: US 2021/0118000 A1
(43) Pub. Date: Apr. 22, 2021

(54) VEHICLE AFTERMARKET SLOTTING SYSTEM

(71) Applicant: Matthew S. Reck, Wake Forest, NC (US)

(72) Inventor: Matthew S. Reck, Wake Forest, NC (US)

(21) Appl. No.: 16/659,787

(22) Filed: Oct. 22, 2019

(51) Int. Cl. G06Q 30/02; G06Q 30/06

(52) U.S. Cl. CPC G06Q 30/0213; G06Q 30/0643; G06Q 30/0222; G06Q 30/0283

(57) ABSTRACT

The invention relates to a system for slotting aftermarket vehicle products when a vehicle buyer is purchasing a vehicle online.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to vehicle sales websites and systems. In particular, it relates to a system and method of associating aftermarket products with online vehicle sales.

### Description of Related Art

The sale of new and used vehicles, such as cars, trucks, and the like, at dealers are normally concluded with a visit with the Finance and Insurance (FI) arm of the dealer once the main contract is signed. Not only are financing of the vehicle, licensing, and insurance discussed by the FI, there is also a chance for the dealer to sell aftermarket products to the vehicle purchaser.

Vehicle aftermarket products are usually third party add-ons to the vehicle, including warranties, extra parts, chemicals, equipment, accessories, and the like. Aftermarket products are an important source of additional income for the dealer since they receive a commission on the aftermarket sales. When one is at the dealer exposing the purchaser to aftermarket products, it is relatively easy since there must be a face to face financing meeting.

More and more, vehicles are purchased entirely online. It is convenient and allows the purchase from the comfort of the home. Selling aftermarket products after an online vehicle sale has turned out to be much more difficult to impossible, thus depriving dealers from a significant portion of their income. A better system for selling aftermarket vehicle products is sorely needed.

### BRIEF SUMMARY OF THE INVENTION

The present invention relates to the invention of a system for presenting aftermarket products to a potential purchaser before they actually purchase the product. This allows the purchaser to either purchase the product with the car or at least make the purchaser familiar enough with the product to consider it after the sale is finalized.

Accordingly, in one embodiment, there is a system for slotting one or more vehicle aftermarket products for sale by a vehicle dealer to a vehicle purchaser comprising:
a) a vehicle dealer sales website;
b) executable software program associated with the vehicle dealer sales website which:
   i. causes the website to show a list of the aftermarket products on a vehicle dealer sales website page of the vehicle dealer in association with a vehicle being sold to a vehicle purchaser on the website; and
   ii. prioritizes the presentation of each of the one or more vehicle aftermarket products to the vehicle purchaser based on an applied slotting fee; and
c) wherein the system allows one or more of the following:
   i. one or more aftermarket products to be sold to the vehicle purchaser on the vehicle dealer sales website; and
   ii. information of an interest by the vehicle purchaser in the aftermarket product to be sent to the vehicle dealer for follow-up.

### BRIEF DESCRIPTION OF THE DRAWINGS

FIG. 1 is a relationship drawing of the system of the present invention.

FIG. 2 is a flow chart of the process of slotting and presenting aftermarket products to a vehicle purchaser.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “slotting” refers to the process of third parties with aftermarket products to sell to vehicle purchasers. First, paying for the privilege of showing up on the vehicle dealers' sales website (such as when the purchaser is looking at a car or decides to buy a car). And, second, being placed on the website in a priority that is based on a selected criteria such as how much they pay or bid.

As used herein, the term “vehicle aftermarket products” refers to the motor vehicle secondary market of the vehicle industry, concerned with the manufacturing, remanufacturing, distribution, retailing and installation of all vehicle parts, chemicals, equipment, and accessories, after the sale of the automobile by the original equipment manufacturer (OEM) or other vehicle dealer to the vehicle purchaser. The parts, accessories, etc. for sale may or may not be manufactured by the OEM. The aftermarket products are parts, or the like, made for comfort, convenience, performance, safety, or customization, and are designed for add-on after the original sale of the vehicle. The aftermarket encompasses parts for replacement, collision, appearance, and performance, including electric propulsion. The aftermarket provides a wide variety of parts of varying qualities and prices for nearly all vehicle makes and models.

As used herein, the term “vehicle dealer” refers to an entity who is selling a vehicle utilizing a vehicle dealer website. This can be an OEM dealer selling new cars, a used car sales dealer, or the like.

As used herein, the term “sales website” refers to a website run buy a vehicle sales dealer that can be used to purchase a vehicle by a vehicle purchaser. With the implementation of the present invention, the website will also provide the ability to review and purchase aftermarket products.

As used herein, the term “executable program software” refers to an executable computer software program, sometimes simply referred to as an executable or binary, which causes a computer to perform indicated tasks according to encoded instructions. The program can be on the same computer or server as the vehicle dealer sales website or on a different computer or server as needed.

As used herein, the term “associated with” refers to the software hosted on the dealer website, dealer server, or a third party computer or server such that the executable software can operate on the dealer sales website.

As used herein, the term “list” refers to a collection of all the different aftermarket products available on the website presented in such a way that they can review them one at a time with each product prioritized in the order vehicle purchaser will see the products.

As used herein, the term “prioritizes” refers to slotting such that each aftermarket product seller has paid for being on the website list wherein the order that they appear is based on how much they pay. In one embodiment, the pay and order can be determined by auction bidding.

As used herein, the term “routed to a separate website page” refers to the vehicle purchaser being able to move to another website page (associated with the vehicle dealer or with a 3^{rd} party) to receive further information where the aftermarket product is explained in more detail either by description, pictures, or the like.

As used herein, the term “sold” refers to the vehicle purchaser being able to purchase the aftermarket product in addition to purchasing the vehicle.

As used herein, the term “follow-up” refers to the vehicle dealer contacting the vehicle purchaser to answer questions, troubleshoot, and the like regarding the purchase of a vehicle.

As used herein, the term “vehicle” refers to a motor vehicle such as an automobile, truck, van, or the like which is to be purchased on a vehicle dealer website. Further, one embodiment of the system includes information brochures.

### Drawings

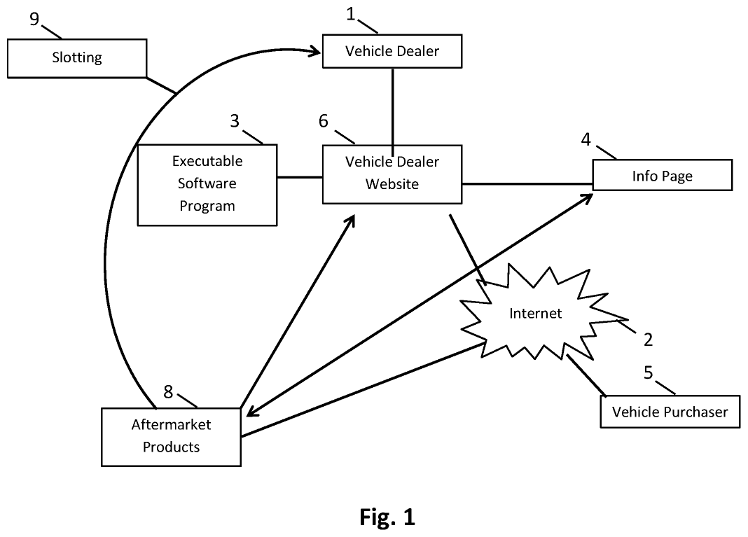

Now referring to the drawings, FIG. 1 is a relationship drawing of the system of the present invention. A vehicle dealer 1 has vehicle dealer website 6 which is viewable on the Internet 2. The website 6 will be viewed by a potential vehicle purchaser 5 who views the website 6 on the Internet 2. During this process, the vehicle purchaser 5 will be shown aftermarket products 8 which have been slotted 9 and appear on the website as slotted 9. In one embodiment, there is also an info page 4 which provides additional information on the aftermarket products 8. This additional page can be on the vehicle dealer website or at a third party vender of the aftermarket product. Executable software program 3 controls the website as well as the slotting procedure.

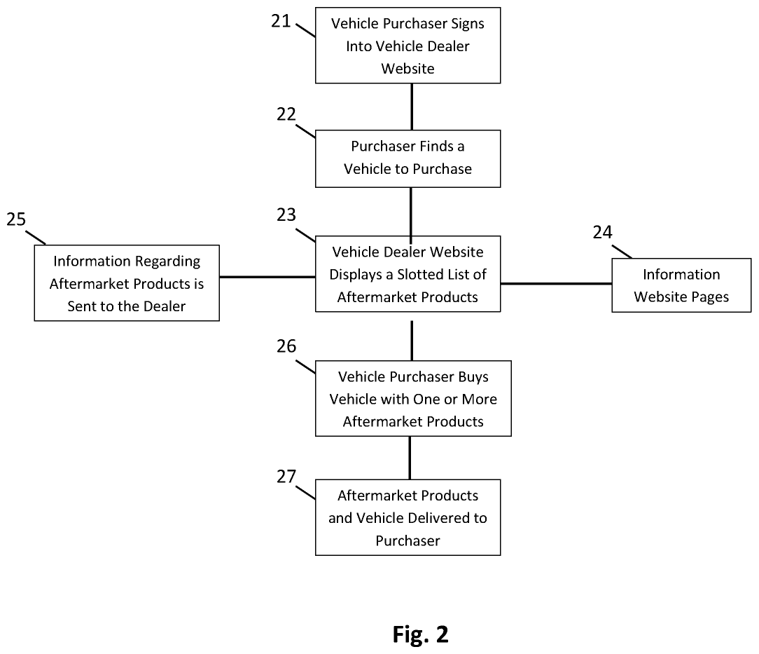

FIG. 2 is a flow chart of the process of slotting and presenting aftermarket products to a vehicle purchaser. To start, a vehicle purchaser signs onto a vehicle dealer website 21. The purchaser browses the offerings and finds a vehicle to purchase 22. Once there is a vehicle picked, the vehicle dealer displays a slotted list of aftermarket products 23. In one embodiment, the purchaser can go to an information page 24 to learn more about the aftermarket product. In another embodiment, the interest in an aftermarket product is sent to the dealer 25. Once the vehicle purchaser has purchased a vehicle and selected one or more aftermarket products 26, the vehicle dealer can deliver the vehicle with aftermarket products to purchaser 27.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description, or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for locking the slotting order of one or more vehicle aftermarket products for sale by a vehicle dealer to a vehicle purchaser in an online transaction comprising:
a) a vehicle dealer sales website selling one or more vehicle aftermarket products selected from the group consisting of vehicle parts, chemicals, vehicle equipment, and vehicle accessories ;
b) executable software program associated with the vehicle dealer sales website which:
i. causes the website to show a list of the one or more aftermarket products for sale in a locked order on a vehicle dealer sales website page of the vehicle dealer in association with a vehicle being sold to a vehicle purchaser on the website; and
ii. determines the locked order of the one or more vehicle aftermarket products to the vehicle purchaser based on an applied slotting fee; and
c) wherein the system allows one or more of the following:
i. one or more aftermarket products to be sold to the vehicle purchaser on the vehicle dealer sales website; and
ii. information of an interest by the vehicle purchaser in the aftermarket product to be sent to the vehicle dealer for follow-up.

2. The system according to claim 1 wherein the executable software is hosted on a server separate from a server hosting the dealer vehicle website.

3. The system according to claim 1 wherein the executable software is hosted on the same server as the dealer vehicle website.

4. The system according to claim 1 which allows the vehicle purchaser to be routed to a separate website page for further information about the vehicle aftermarket product.

5. A The system according to claim 1 which further includes information brochures.
